(19) United States
(12) Patent Application Publication
(10) Pub. No.: US 2007/0084911 A1
(43) Pub. Date: Apr. 19, 2007

(54) ATM check invalidation and return systems and methods

(75) Inventor: Donald R. Crowell, Glassboro, NJ (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: First Data Corporation, Englewood, CO (US)

(21) Appl. No.: 11/253,340

(22) Filed: Oct. 18, 2005

(51) Int. Cl. G07F 19/00

(52) U.S. Cl. 235/379

(57) ABSTRACT

Systems, methods, and software are described for check processing at an ATM. A check may be received at an ATM, and an image of the check may be captured. It may then be verified that the image captured meets an established quality standard. The ATM may then print on the check to indicate that it is not negotiable, and the check may be discharged from the ATM to the user.

### BACKGROUND OF THE INVENTION

Automatic Teller Machines (“ATMs”) are widely used by customers of financial institutions to perform transactions related to financial accounts. ATMs may be used for a variety of purposes, including the deposit or withdrawal of funds to such financial accounts. ATM's may also be used for credit card cash advances and other transactions, money transfers, payments (e.g., payment of a bill), balance inquiries, purchase items (e.g., stamps), and other types of transactions involving the making and receiving of payments.

One of the most common transactions involves the deposit of a check. The customer may insert an ATM card and input a personal identification number (“PIN”), and may enter the amount of the check. A check or checks may be included in an envelope, and input into the ATM. The deposited amount may then be credited to the customer's account, or the amount of the check or checks may be cashed.

The passage of the Check21 Act, effective Oct. 28, 2004, has made it easier for banks to electronically transfer check images in lieu of paper checks. The Act allows banks to replace checks, in certain circumstances, with substitute checks based on captured images. Under the Act, such a substitute check may be processed as if they were an original check.

Under many current practices, ATMs retain physical checks, requiring them to be collected on a regular basis. This practice can be expensive. There is, thus, a need in the art to create an alternative solution allowing automated deposit of checks without the need to retrieve them, while making use of the imaging options under Check21.

### BRIEF SUMMARY OF THE INVENTION

Systems, methods, and software for processing a check at an ATM are described. According to various embodiments of the invention, a check may be received at the ATM from a user, and an image of the received check may be captured. The ATM may verify that the image captured meets a quality standard established for check images captured at the ATM. The ATM may then print on the check to indicate that the check is not negotiable; and may discharge the check from the ATM to the user.

In other embodiments, an ATM network host computer system may receive a first communications signal from an ATM comprising an image of a check and a request for a transaction. The ATM network host may verify that the image meets an established quality standard, and may determine whether the transaction is authorized. The ATM network host may transmit a second communications signal, directing the ATM to print on the check to indicate that it is not negotiable and discharge the printed check to the user.

In certain embodiments of the invention, an ATM may communicate with an ATM network host computer system with encrypted, formatted messages. In some embodiments, a user may be authenticated with an ATM card number or other identifier, and a matching personal identification number (“PIN”).

In various embodiments, a user may be queried as to whether the user wants the check returned. The ATM may receive input from the user via an input interface. In certain embodiments, the input may comprise the amount of the check. In some embodiments, the ATM may analyze the image to determine an amount of the check automatically with character recognition software. The ATM may also read MICR data, and may verify the authenticity of a check in a variety of ways.

In various embodiments, an ATM network host may analyze a received check image to determine an amount of the check automatically with character recognition software. The ATM network host may also analyze such an image to read MICR data in the image, or to determine the authenticity of the check. According to various embodiments of the invention, a transaction may comprise the deposit or cashing of a check. In some embodiments, an ATM network host may verify that the account associated with the check has a sufficient balance to cover the check, or that the account associated with the user has a sufficient balance to cover the check. The systems and methods described above may be performed by an apparatus set forth in the description which follows, which may include an input device, an image capture device, and a printer. The above systems and methods may also be embodied on a computer readable medium.

### BRIEF DESCRIPTION OF THE DRAWINGS

A further understanding of the nature and advantages of the present invention may be realized by reference to the following drawings. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 illustrates a communications system that may be used to process and return a check to a user at an ATM according to various embodiments of the present invention.

FIG. 2A is a schematic diagram of an exemplary ATM that may be used to receive and return a check to a user according to various embodiments of the present invention.

FIG. 2B is a schematic diagram of an exemplary ATM that may be used for check receipt and return according to various embodiments of the present invention.

FIG. 3 is a flow diagram that illustrates a method that may be used by an ATM to return a received check according to various embodiments of the present invention.

FIG. 4 is a flow diagram that illustrates a method that may be used by an ATM in an ATM network to automatically receive, print upon, and return a check to a user according to various embodiments of the present invention.

FIG. 5 is a flow diagram that illustrates an alternative method that may be used by an ATM in an ATM network to automatically receive, print upon, and return a check to a user according to various embodiments of the present invention.

FIG. 6 is a flow diagram that illustrates a method for an ATM network host computer system to direct an ATM to return a received check to a user according to various embodiments of the present invention.

FIG. 7 is a flow diagram that illustrates a method for an ATM network host computer system to process a received check image from an ATM, and to direct the ATM to return the check to a user according to various embodiments of the present invention.

FIG. 8 is a schematic diagram that illustrates a representative device structure that may be used in various embodiments of the present invention.

### DETAILED DESCRIPTION OF THE INVENTION

This description provides exemplary embodiments only, and is not intended to limit the scope, applicability or configuration of the invention. Rather, the ensuing description of the embodiments will provide those skilled in the art with an enabling description for implementing embodiments of the invention. Various changes may be made in the function and arrangement of elements without departing from the spirit and scope of the invention as set forth in the appended claims.

Thus, various embodiments may omit, substitute, or add various procedures or components as appropriate. For instance, it should be appreciated that in alternative embodiments, the methods may be performed in an order different than that described, and that various steps may be added, omitted or combined. Also, features described with respect to certain embodiments may be combined in various other embodiments. Different aspects and elements of the embodiments may be combined in a similar manner.

It should also be appreciated that the following systems, methods, and software may be a component of a larger system, wherein other procedures may take precedence over or otherwise modify their application. Also, a number of steps may be required before, after, or concurrently with the following embodiments.

I. Overview: Systems, methods, and software are described for check processing at an ATM. A check may be received at an ATM, and an image of the check may be captured. It may then be verified that the image captured meets an established quality standard. The ATM may print on the check to indicate that it is not negotiable, and the check may be discharged from the ATM to the user.

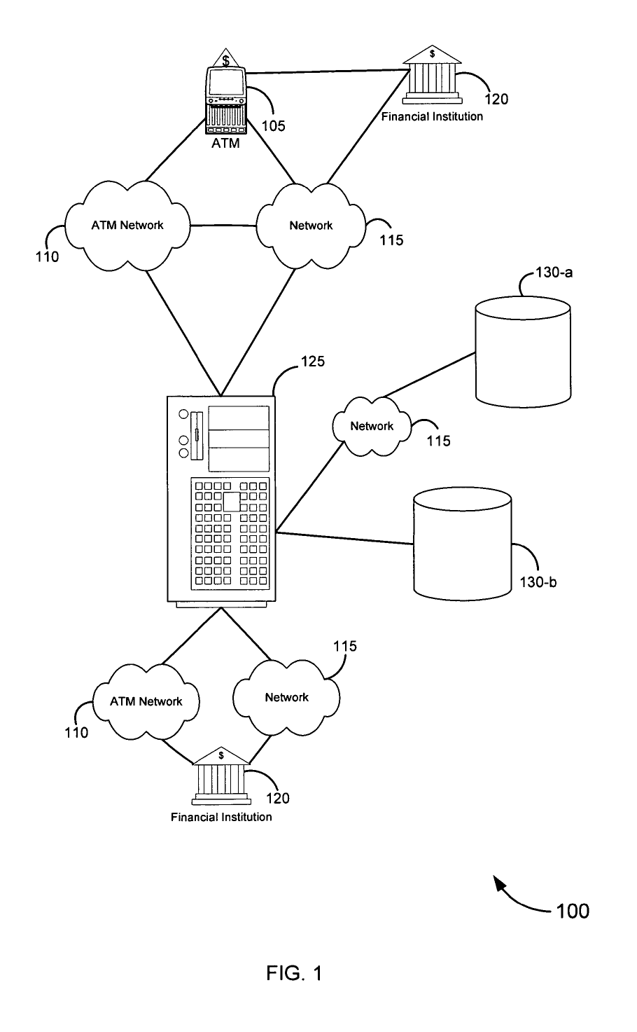

II. System Architecture: FIG. 1 illustrates an example of a Communications System 100 within which various embodiments of the present invention may be included. The System 100 components may be directly connected, or may be connected via a Network 115, which may be any combination of the following: the Internet, an IP network, an intranet, a wide-area network (“WAN”), a local-area network (“LAN”), a virtual private network, the Public Switched Telephone Network (“PSTN”), an ATM network, or any other type of network supporting data communication between devices described herein, in different embodiments. A Network 115 may include both wired and wireless connections, including optical links. Many other examples are possible and apparent to those skilled in the art in light of this disclosure. In the discussion that follows, a Network 115 may or may not be noted specifically. If no specific means of connection is noted, it may be assumed that the link, communication or other connection between devices may be via a Network 115.

1. ATM: The System 100 may include an ATM 105. As used herein, the term “ATM” may comprise a machine, kiosk, or other apparatus which automatically receives one or more checks from a user for purposes of deposit or cashing. A check may comprise any check, instrument, draft, note or other negotiable instrument which directs a financial institution to pay a specific amount of funds from a specific account to the payee. The funds to be allocated may be drawn from an account or group of accounts selected from the following: a stored-value account, a stored-value card account, a credit card account, a bank account, a savings account, or any other financial account from which funds may be drawn.

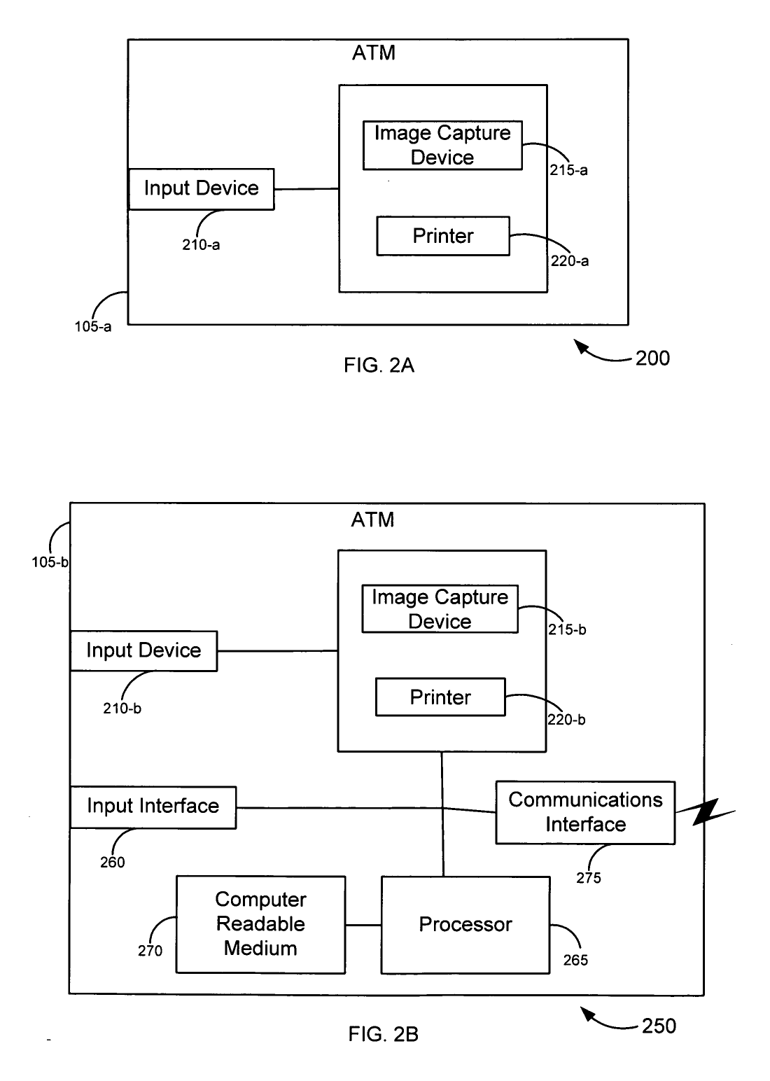

FIG. 2A illustrates an exemplary block diagram 200 of an ATM 105 that may be used to receive a check according to various embodiments of the invention. The ATM 105-a may include an input device 210-a. An input device 210-a may comprise an apparatus which is housed in, or otherwise coupled with, the ATM 105, to receive automatically a check or checks from a user. An input device 210-a may be configured to receive more than one check simultaneously, or receive any number of checks in succession.

The input device 210-a may be configured to directly receive a check (i.e., receive the check itself, not the check enclosed in an envelope), and may be integrated with an image capture device 215-a. An image capture device 215 may be configured to capture an image of the received check. There are a variety of image capture devices that are commercially available, and able to be integrated with the input device 210-a. The image capture device 215 may be configured to capture images on one, or both, sides of a received check. The image capture device 215 may be communicatively coupled with a computer readable storage medium 270 and the processor 265 for local or remote storage and processing, as illustrated in FIG. 2B. The image capture device may be configured to capture the image of the check in analog or digital form, or transform an analog image to digital. Such processing may also take place with image processing software included on the image. The capture may be bitonal, grayscale, or color, and the capture device may be configured to detect watermarks or other magnetic or optical changes on or in a check. The image capture device 215, or the image device 210, may be configured to rotate, zoom, or move a check to take different images. The image capture device 215 may capture an image of a check before, or after, the check has been printed on or otherwise manipulated to indicate that it is not negotiable.

A printer 220-a may also be coupled with the input device 210-a to provide the ability to print upon a received check. A printer 220 may be configured to print on one, or both, sides of a check received via the input device 210. The printer may be integrated into, or otherwise housed in, the input device in any manner known in the art. There are a variety of such printers available commercially. The printer may print on the check to indicate that the check is no longer negotiable (e.g., it could print “void,” “not negotiable,” “invalid,” “deposited,” etc.). The printer may print on the check with other information as well, such as date, time, terminal ID, location, ATM card number, other transaction identification information, other information about the user, other terms which indicate that the check is no longer negotiable, and any combination thereof. The printer may be configured to use different colors or types (i.e., magnetic) of ink. The printer may be directed to print on the check by the ATM 105 or an ATM Network Host 125. The printing may be undertaken as a result of the successful deposit or cashing of a check, or for other reasons (e.g., already cashed, suspected fraud, etc.)

A magnetic ink character recognition (“MICR”) reader may also be coupled with, or otherwise integrated into, the input device 210. The reader may recognize and read MICR data on a check received via the input device 210. A variety of such readers are commercially available, and are well known in the art. The input device 210 may also be configured to perform other actions upon the check, such as cutting, embossing, or otherwise physically manipulating a check, or affixing another item to the check (e.g., a sticker or receipt). Such action may, or may not, indicate that the check is not negotiable.

Referring to the block diagram 250 of FIG. 2B, an ATM 105-b may further include components in addition to an input device 210-a, an image capture device 215-b, and a printer 220-b. For example, in some embodiments, the ATM 105-b may include an input interface 260. An input interface 260 may comprise multiple components, such as a card reader, display, keypad, receipt printer, and cash dispensing mechanism. A card reader may be used to receive a card (e.g., ATM card, credit card, driver's license, smartcard, etc.) to obtain a financial account number, card number, or other identifier to identify the account for which the transaction will take place. A display may be used to prompt a user for responses which may be needed to perform a transaction, and to display information to the user. The display may include touchscreen functionality. Additionally, as will be described in further detail below, a display may be used to show a query from an ATM Network Host Computer System 120.

A keypad may be used to receive input from the user, such as a personal identification number (“PIN”) associated with the user's financial account, transaction selections, dollar amounts for transactions, and other information related to a user's transaction with the ATM 105-b. A keypad (which may optionally comprise a touchscreen, either stand alone or a component of the display) may be used to receive input from a user comprising a request to deposit a check or checks to an account, a request to cash a check, or a request to have a check returned. The input interface 260 may further include a biometric input device to receive biometric information, and biometric authentication may be used in conjunction with, or in place of, a card reader or PIN. A variety of such biometric input devices are known in the art. A user interface 260 may also include a printer that may be used to print a receipt of a transaction. Other items, such as a microphone and speaker, or a video camera, may be integrated into or otherwise coupled with an input interface 260 to provide for input or other communication via the communications interface 275.

An ATM 105-b may further include a computer readable medium 270 containing any number of applications, programs, or other code designed to implement methods of the invention. An ATM 105-b may further include a processor 265 configured to execute instructions stored on the computer readable medium 270. An ATM 105-b may further comprise a communications interface 275, to allow a program included in the computer readable medium 270 to communicate with an ATM Network Host Computer System 125. In various embodiments, an ATM 105 may comprise a computing device, as described below. It should also be appreciated that in alternate embodiments, the ATM 105 may comprise fewer or additional components than described above.

The program included on the computer readable medium 270 may process a transaction or other request initiated by a user of the ATM 105-b. Such a program may direct the display to show a query to a customer regarding whether he or she wants a check received by the ATM 105-b to be returned. Such a query may originate from an ATM Network Host 125 or the ATM 105. A program may receive a request from a user, via the input interface 260, to deposit or cash a check, and use the communications interface 275 to communicate with an ATM Network Host Computer System 125 though the ATM network 110 or other Network 115. A program may encrypt or decrypt any portion of a communications signal to be sent or received via the communications interface 275. A communications signal, as that term is used throughout the Application, may comprise any number of signals (i.e., the information may be sent in any number of different signals or packets). The number of signals may be sent at different times, as well.

A number of different actions may be undertaken via the ATM 105 and its various components. The computer readable medium 270 may include character recognition (“OCR”) software to read automatically check amounts and other information included on checks. Various types of optical character recognition software may be used to translate images into a variety of forms or text that are computer readable. Such character recognition software is commercially available, and known in the art. Also, software may be stored on the computer readable medium 270 which may analyze the check or captured check images to ensure that a check for deposit or cashing is authentic (e.g., via encrypted check identification number, watermark, automated pattern recognition, etc.). A range of this type of software is also known in the art, and commercially available.

2. ATM Network: The communications interface 275 may be directly or indirectly communicatively coupled with an ATM network 110 to provide for communication with an ATM Network Host 125. By way of example, the communications interface 275 may comprise a modem, a network interface card, or other wireless card connecting the ATM 105 to a phone line, a 4 wire dedicated phone line, a dedicated data line, a wireless network, an optical network, or other communication medium known in the art. By way of example, ATM code 270 may use the communications interface 275 to communicate with the ATM Network Host 125 to thereby authenticate a user's financial account number and PIN, approve a transaction, transmit a captured image, and so on.

As noted above, an ATM 105 may have a direct, or indirect, communication coupling to an ATM network 110. Therefore, the communications interface 275 may be communicatively coupled with an other Network 115, and such a Network 115 may be communicatively coupled with the ATM network 110. For example, an ATM 105 may be communicatively coupled to ATM network 110 through a Network 115 of a Financial Institution 120 associated with the ATM 105. As used herein, the term “financial institution” may comprise a bank, a savings and loan, a credit card company, an investment company, a mortgage company, a mutual fund company, or any other business entity that provides financial services. The ATM network 110 may be used to obtain information and authorization for an ATM 105. The ATM network 110 may be able to communicate with a Financial Institution 120 associated with the ATM customer's financial account. By way of example, the ATM network 110 may comprise a network such as the NYCE® network, the Pulse® network, the STAR® network, and the like. An ATM 105 may also be communicatively coupled directly with a Network 115 of a Financial Institution 120 associated with the ATM 105. A variety of combinations are possible, and apparent to those skilled in the art.

3. ATM Network Host and Database: The ATM Network Host Computer System 125 may communicate with an ATM 105 to receive a captured image of a check in the manner described above, or may receive an image via other means. The ATM Network Host 125 may also receive a request for a transaction from a user, as well as various user authentication and identification information, and transaction identifiers. The ATM Network Host 125 may include, for example, one or more server computers, workstations, web servers, or other suitable computing devices. The ATM Network Host 125 may be fully located within a single facility or distributed geographically, in which case an ATM network 110 or other Network 115, as described above, may be used to integrate different components. An ATM Network Host 125 may comprise any computing device configured to process, manage, complete, analyze, or otherwise address, in whole or in part, a request to authenticate an ATM user, a request to authorize a transaction, or a request to process a captured check image from an ATM 105, either directly or indirectly.

Application software running on the ATM Network Host 125 may receive a captured image of a check, and query a Database 130 (directly, or indirectly through an intermediary such as a Financial Institution 120). The purpose for such a query may be to 1) identify the account of the user, 2) authenticate the user or check, 3) identify the account associated with the check, 4) determine whether there are sufficient funds in the account associated with the check, or 5) determine whether there are sufficient funds in the account of the user (or sufficient credit available) to cover the check. Application software at the ATM Network Host 125 may include image quality analysis software to analyze any of the following factors: image size, lightness, darkness, horizontal or vertical streaks, skew, folded or torn comers, framing errors, noise, dimension mismatch, focus, and so on. An Application may also include character recognition software to read automatically amounts included on checks, and software to analyze a check image to ensure the check is authentic and not fraudulent. Application software may also include a program to analyze the MICR data of a received image. Software described in this paragraph is known in the art, and commercially available.

In some embodiments, an ATM Network Host 125 may receive a communications signal from the ATM 105. In various embodiments, the signal may comprise an encrypted, formatted message. As used herein, an “encrypted, formatted message” may include any formatted message in which any part of the message is encrypted. The encrypted, formatted message may include an ATM card number, a personal identification number (“PIN”), and an identifier for the ATM 105. In some embodiments, only the PIN is encrypted. The ATM Network Host 125 may receive the signal, decrypt the encrypted portion, and process the formatted message to determine whether the PIN matches the PIN associated with the card number. The ATM Network Host 125 may also transmit an message which is encrypted, in whole or in part, to the ATM 105, as known in the art. In alternative embodiments, the ATM Network Host may receive an other account identifier in lieu of the ATM card number, such as an ATM card account number, a credit card account number, a social security number, a bank account number, a savings account number, a stored-value account number, a personal identification number, a unique character set, a unique data set, and any combination thereof. In lieu of a PIN, the ATM Network Host 125 may receive any other passcode, password, or other form of authentication (e.g., biometric input).

An ATM Network Host 125 may be in communication (directly or indirectly) with a Database 130. The Database 130 may comprise one or more different databases, which may be located within a single facility or distributed geographically, in which case a Network 115, as described above, may be used to integrate different components. A Database 130 may maintain or otherwise store information on a plurality of accounts at different Financial Institutions 120. In some embodiments, the Database 130 may comprise a database maintained or operated by a Financial Institution 120, and comprising information about user accounts (e.g., valid account number/PIN combinations, balances, etc.). According to different embodiments of the invention, the Database 130 may include any number of tables and sets of tables. One or more of the databases may be a relational database. The Database 130 may be incorporated within the ATM Network Host 125 (e.g., within its storage media), or may be a part of a separate system. The ATM Network Host 125 may, therefore, comprise the Database 130. The Database 130 may be organized in any manner different than described above to provide the functionality called for by the various embodiments, as known by those skilled in the art.

Many different methods may be used by the ATM Network Host 125, or the ATM 105, to accept or otherwise validate a check, including verifying the existence of the bank and account number associated with the check. The variety of factors discussed herein may be assigned different weights, and added together to determine a “score” for a particular check and user. A decision on whether to authorize the transaction may be based on the score. Having described various aspects of the invention, a better understanding of the embodiments of the system may be gained with further discussion of the various methods of receiving a check via an ATM, and the systems and software that support them.

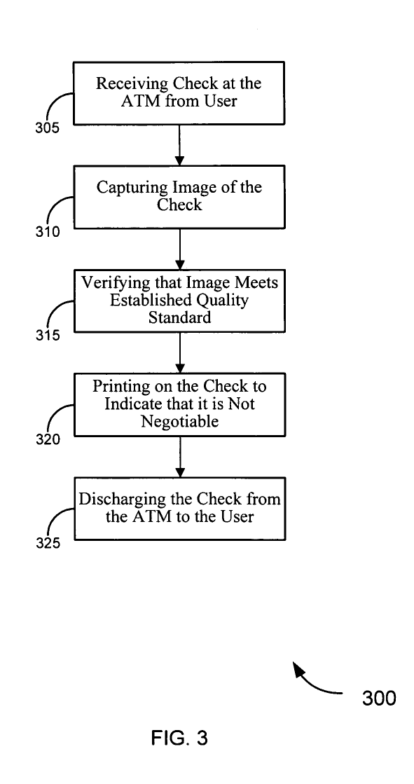

III. Exemplary Embodiments: FIG. 3 sets forth a first exemplary embodiment 300 of the invention, illustrating an example of a method for processing a check at an ATM. At block 305, an ATM may receive a check from a user. The ATM may, at block 310, capture an image of the check. At block 315, the ATM may verify that the captured image meets an established quality standard. The ATM may print on the check, at block 320, to indicate that it is no longer negotiable. At block 325, the ATM may discharge the check to user.

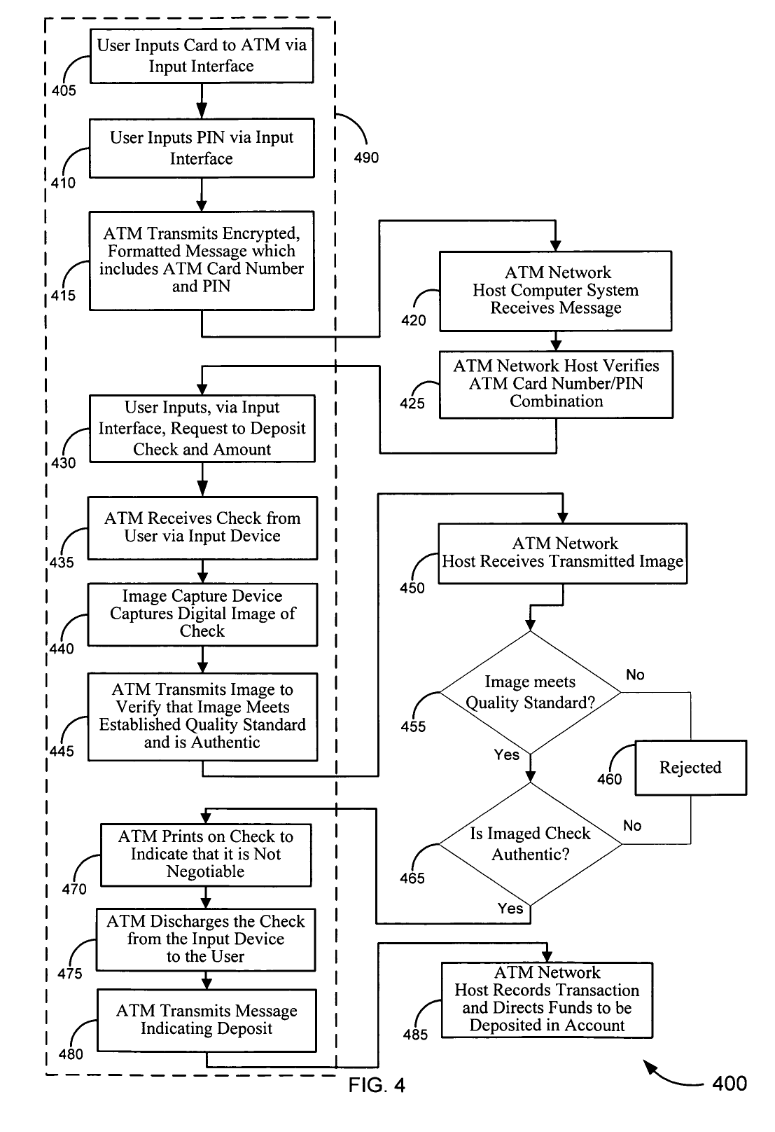

FIG. 4 sets forth an alternative exemplary embodiment 400 of the invention, again illustrating a method for processing a check at an ATM 105. At block 405, a user may input a card to the ATM 105 via a card reader included in the input interface 260. At block 410, the user may input a PIN via a touchscreen or keypad in the input interface 260. The ATM, at block 415, may encrypt and format a message, which may include the ATM card number and PIN. The ATM may then transmit the encrypted, formatted message. At block 420, the ATM Network Host Computer System 125 may receive and decrypt the message. At block 425, the ATM Network Host 125 may verify the ATM card number/PIN combination is valid, by reference to a Database 130 listing valid ATM card number/PIN combinations and accessed through communication with a Financial Institution 120. The ATM Network Host 125 may then transmit an encrypted message, including the verification.

With receipt and decryption of the verification, the ATM 105 may query a user to determine whether a check is to be deposited. At block 430, a user may input, via an input interface 260, a request to deposit a check and an amount of the deposit. The request may, for example, be input through a keypad or touchscreen. The ATM 105 may then, at block 435, receive a check from a user via the input device 210. At block 440, the image capture device may capture a digital image of the check, in any manner as described above. In alternative embodiments, an analog image may be captured. At block 445, an ATM 105 may transmit the captured image in an encrypted, formatted message to an ATM Network Host 125 to verify that the image meets established quality standards and is authentic.

At block 450, the ATM Network Host 125 may receive and decrypt the transmitted image. At block 455, the ATM Network Host 125 may determine whether image meets an established quality standard. Such a quality standard may be specified by a government or other regulatory body, or may be otherwise set forth. In some embodiments, the standard may comprise a Financial Services Technology Consortium's (“FSTC”) or ANSI X9B standard for image quality. In other embodiments, the standard for the image captured may require that the image be sufficient to produce a substitute check, as that term is used in the Check21 Act. An Application stored on the ATM Network Host 125, or associated Database 130, may be programmed with the established standard, or the standard may be selected on the basis of factors associated with the transaction. If the established standard is not met, the transaction may be rejected at block 460. The term “rejected” may comprise processing the check in another fashion, or terminating the transaction in its entirety. If the quality standard is met, the ATM Network Host 125 may determine whether the imaged check is authentic, at block 465. If not, again the transaction may be rejected at block 460.

If the imaged check is deemed authentic, the ATM Network Host 125 may transmit an encrypted message to the ATM, which may, at block 470, print on the check with the printer 220 to indicate that the check is not negotiable. At block 475, the ATM may discharge the check from the input device to the user. At block 480, the ATM may transmit a message indicating that the deposit was made, and such a message may be encrypted. At block 485, the ATM Network Host may record the transaction, and may direct the amount to be deposited into the specified account. The dashed area indicated by the reference numeral 490 illustrates the actions that may be undertaken at the ATM, according to various embodiments of the invention.

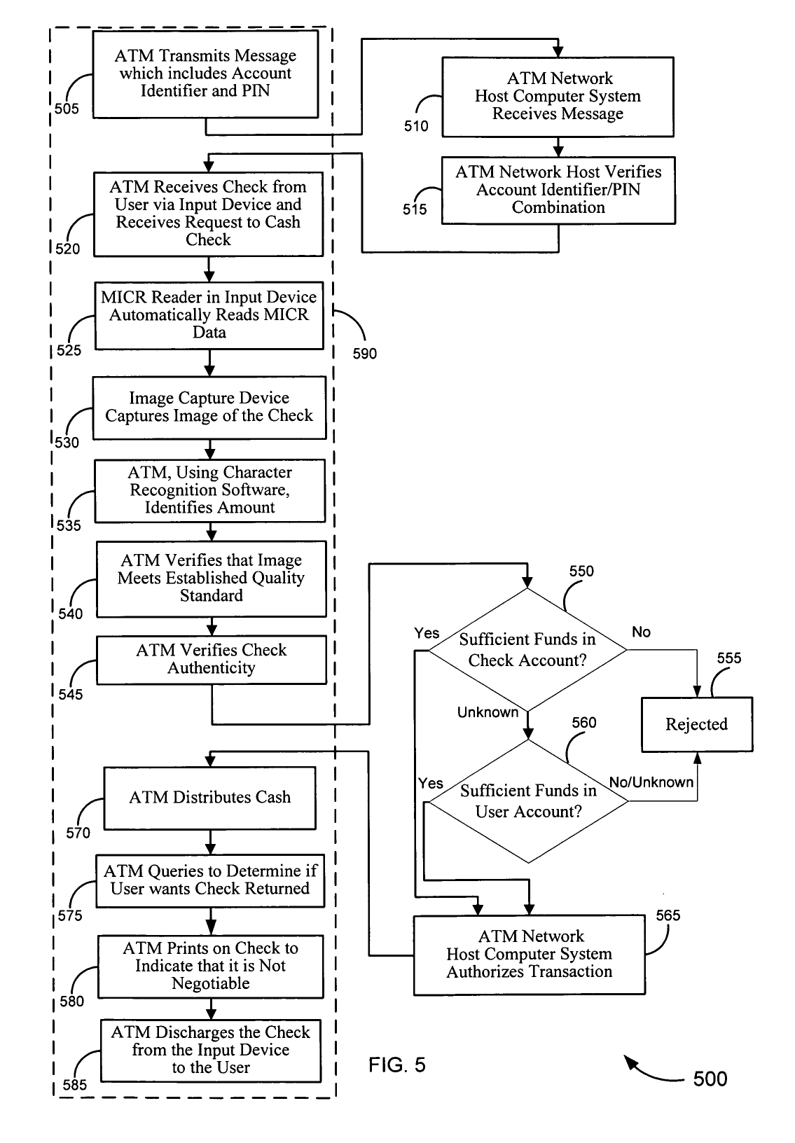

FIG. 5 sets forth yet another alternative embodiment 500 of the invention, again illustrating a method for processing a check at an ATM 105. At block 505, an ATM 105 may transmit a message which includes an account identifier and a PIN. As noted above, an account identifier may comprise any data that uniquely identifies an account associated with a user of an ATM 105. At block 510, an ATM Network Host 125 may receive the message. At block 515, the ATM Network Host 125 may verify that the account identifier and PIN combination is a valid combination by querying a Database 130. The Database 130 may contain a number of account identifier and PIN combinations, which may indicate a valid or authentic user.

At block 520, the ATM 105 may receive a check from the user via the input device 210, and may further receive a request from the user via the input interface 260 to cash the check. A MICR reader housed in the input device 210 may, at block 525, automatically read the MICR data from the check. At block 530, an image capture device 215 may capture the image of the check. The ATM 105, at block 535, may use character recognition software stored on its computer readable medium 270 to identify the amount of the check. At block 540, the ATM may verify that the image meets an established quality standard, with software capable of image quality measurement stored on its computer readable medium 270. Alternatively, in other embodiments, the image quality measurement software or character recognition software may be stored remotely. At block 545, the ATM 105 may verify that the check is authentic, again using software stored locally, or remotely. When an ATM 105 determines that a check is authentic and image quality is sufficient, a number of determinations may be made at the ATM Network Host 125.

In some embodiments, and as illustrated at block 550, the ATM Network Host 125 may determine whether there are sufficient funds in the account associated with the check to fund the amount of the check. If not, the transaction may be rejected at block 555 according to some embodiments. As noted above, the term “rejected” may comprise processing the check in an alternative manner, or terminating the transaction in its entirety. If it cannot be determined whether there are sufficient funds in the checking account to fund the check, the ATM Network Host 125 may make an alternative query. In some embodiments, the ATM Network Host 125 may attempt to verify, at block 560, whether there are sufficient funds in an account associated with the ATM user to cover the check. If there are sufficient funds in either the checking account or the user account, the ATM Network Host 125 may authorize the transaction at block 565, and transmit an authorization message accordingly.

With receipt of the authorization, at block 570, the ATM may distribute cash. In some embodiments, some of the amount of the check may be deposited, and some cashed. At block 575, the ATM may query the user to determine if he or she wants the check returned. The ATM, at block 580, may then print on the check to indicate that it is no longer negotiable. The alternative printing and manipulation of the check, as described above, may also be undertaken. At block 585, the ATM 105 may discharge the check from the input device to the user. According to various embodiments, the dashed area represented by reference numeral 590 indicates the actions that may be undertaken at the ATM 105.

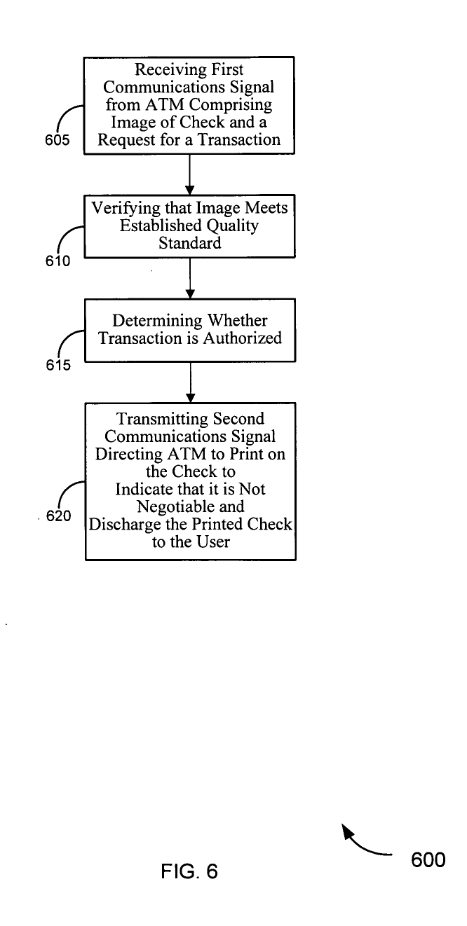

FIG. 6 illustrates another alternative embodiment 600 of the invention, wherein certain actions relating to the processing of a check at an ATM 105 are undertaken at an ATM Network Host 125. At block 605, an ATM Network Host Computer System 125 may receive a first communication signal from an ATM 105, comprising an image of a check and a request for a transaction. At block 610, the ATM Network Host 125 may verify that the image meets an established quality standard. The ATM Network Host 125 may, at block 615, determine whether the transaction is authorized. At block 620, the ATM Network Host 125 may transmit a second communication signal, directing the ATM 105 to print on the check to indicate that the check is not negotiable, and further directing the ATM to discharge the printed check to the user.

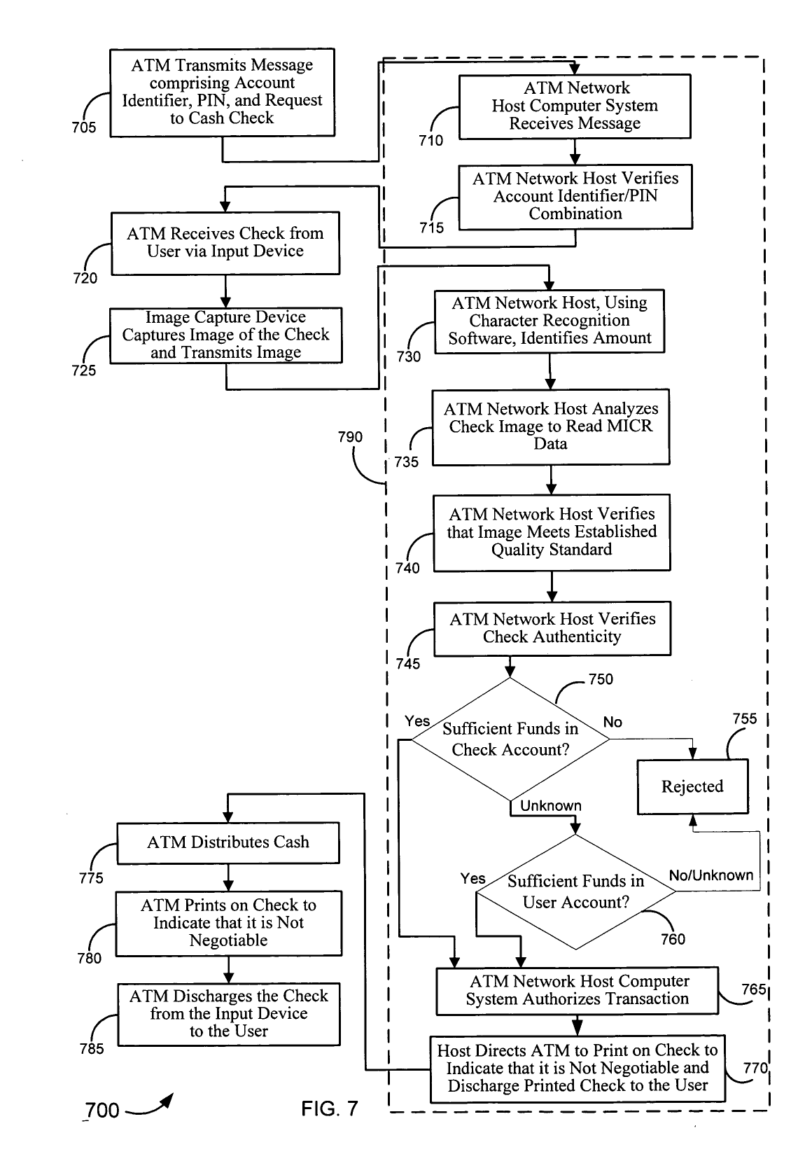

FIG. 7 sets forth another alternative embodiment 700 of the invention, wherein specified actions relating to the processing of a check at an ATM 105 are undertaken by an ATM Network Host 125. At block 705, an ATM 105 may transmit a message comprising an account identifier and a PIN. At block 710, an ATM Network Host Computer System 125 may receive the message, and an ATM Network Host 125 may verify that the account identifier and PIN comprise a valid combination at block 715.

At block 720, an ATM 105 may receive the check from the user via the input device. At block 725, the image capture device may capture the image of the check, and transmit the image to the ATM Network Host 125. The ATM Network Host 125, using character recognition software, may identify the amount of the check at block 730. The ATM Network Host 125 may then analyze, at block 735, the check image to read the MICR data contained on the check. At block 740, the ATM Network Host 125 may verify that the image meets an established quality standard with image quality analysis software. The ATM Network Host 125, at block 745, may verify that the check is authentic using, for example, systems that employ automated pattern recognition comparisons with known checks.

At block 750, the ATM Network Host 125 may determine whether there are sufficient funds in the account associated with the check. If not, the check may be rejected at block 755, as addressed above. If it is unknown or cannot be otherwise determined whether there are sufficient funds in the checking account, the ATM Network Host 125 may inquire to determine whether there are sufficient funds in the user account at block 760. If it is not known or if the answer is no, again the transaction will be rejected at block 755. However, if there are sufficient funds in the checking account or the user account to cover the check, the ATM Network Host 125 may authorize the transaction at block 765. The ATM Network Host 125 may direct the ATM 105, at block 770, to print on the check indicating that it is not negotiable and to discharge the printed check to the user.

At block 775, the ATM may distribute cash to the user. The ATM, at block 780, may print on the check to indicate that it is no longer negotiable. At block 785, the ATM may discharge the check from the input device to the user. According to various embodiments, the dashed area represented by reference numeral 790 comprises actions that may be undertaken by the ATM Network Host 125.

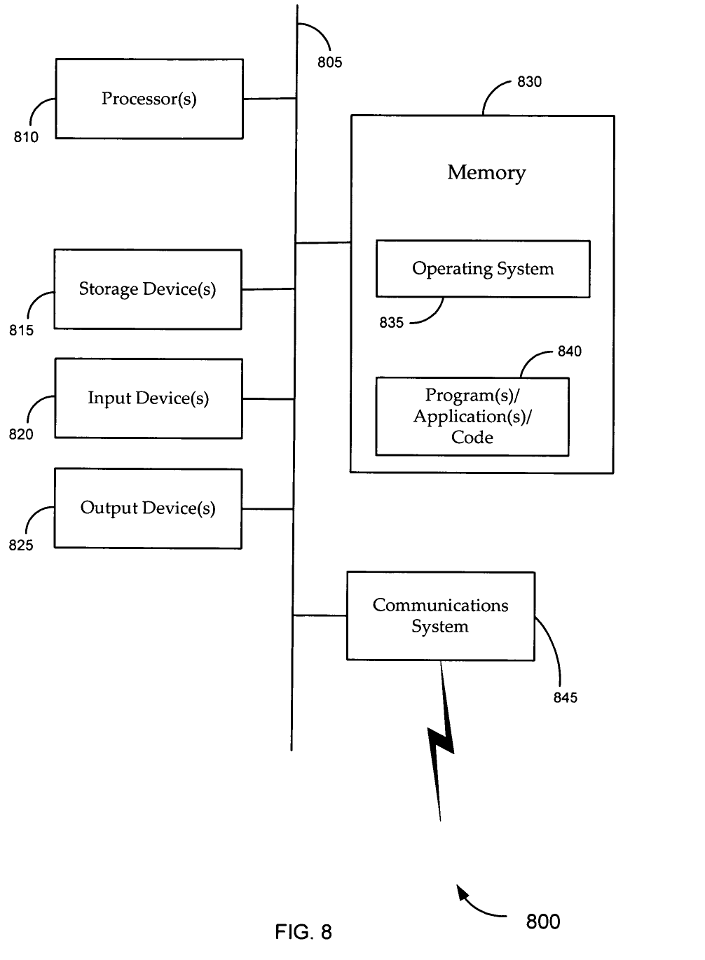

IV. Computing Device Structure: A device structure 800 that may be used for a computer, server, ATM 105, ATM network host computer system 120 or other computing device described herein is illustrated with the schematic diagram of FIG. 8. This drawing broadly illustrates how individual system elements of each of the aforementioned devices may be implemented, whether in a separated or more integrated manner. The exemplary structure is shown comprised of hardware elements that are electrically coupled via bus 805, including processor(s) 810 (which may further comprise a DSP or special-purpose processor), storage device(s) 815, input device(s) 820, and output device(s) 825. The storage device(s) 815 may comprise a computer-readable storage media reader connected to any computer-readable storage medium, the combination comprehensively representing remote, local, fixed, or removable storage devices or storage media for temporarily or more permanently containing computer-readable information. The communications system 845 may comprise a wired, wireless, or other type of interfacing connection that permits data to be exchanged with other devices. The communications system(s) 845 may permit data to be exchanged with a network (including, without limitation, the Network 115).

The structure 800 may also comprise additional software elements, shown as being currently located within working memory 830, including an operating system 835 and other code 840, such as programs or applications designed to implement methods of the invention. It will be apparent to those skilled in the art that substantial variations may be used in accordance with specific requirements. For example, customized hardware might also be used, or particular elements might be implemented in hardware, software (including portable software, such as applets), or both.

V. Conclusion: It should be noted that the methods, systems and devices discussed above are intended merely to be exemplary in nature. It must be stressed that various embodiments may omit, substitute, or add various procedures or components as appropriate. For instance, it should be appreciated that in alternative embodiments, the methods may be performed in an order different than that described, and that various steps may be added, omitted or combined. Also, features described with respect to certain embodiments may be combined in various other embodiments. Different aspects and elements of the embodiments may be combined in a similar manner. Also, it should be emphasized that technology evolves and, thus, many of the elements are exemplary in nature and should not be interpreted to limit the scope of the invention.

Specific details are given in the description to provide a thorough understanding of the embodiments. However, it will be understood by one of ordinary skill in the art that the embodiments may be practiced without these specific details. For example, well-known circuits, processes, algorithms, structures, and techniques have been shown without unnecessary detail in order to avoid obscuring the embodiments.

Also, it is noted that the embodiments may be described as a process which is depicted as a flow chart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in the figure.

Moreover, as disclosed herein, the terms “storage medium” or “storage device” may represent one or more devices for storing data, including read only memory (ROM), random access memory (RAM), magnetic RAM, core memory, magnetic disk storage mediums, optical storage mediums, flash memory devices or other machine readable mediums for storing information. The term “computer-readable medium” includes, but is not limited to, portable or fixed storage devices, optical storage devices, wireless channels, a sim card, other smart cards, and various other mediums capable of storing, containing or carrying instructions or data.

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a machine readable medium such as a storage medium. Processors may perform the necessary tasks.

Having described several embodiments, it will be recognized by those of skill in the art that various modifications, alternative constructions, and equivalents may be used without departing from the spirit of the invention. For example, the above elements may merely be a component of a larger system, wherein other rules may take precedence over or otherwise modify the application of the invention. Also, a number of steps may be required before the above elements are considered. Accordingly, the above description should not be taken as limiting the scope of the invention, which is defined in the following claims.

What is claimed is:

1. A method for processing a check at an Automatic Teller Machine (“ATM”) comprising:
receiving a check at the ATM from a user;
capturing an image of the check;
verifying that the image captured meets a quality standard established for check images captured at the ATM;
printing on the check to indicate that the check is not negotiable; and
discharging the check from the ATM to the user.

2. The method of claim 1, further comprising:
receiving input from the user via an input interface which allows the user to input information into the ATM.

3. The method of claim 2, further comprising:
providing a query to the user to inquire whether the user wants the check returned from the ATM,
wherein the receiving input step comprises receiving a response to the query, indicating that the user wants the check returned.

4. The method of claim 2, wherein the receiving input step comprises receiving input from the user indicating the amount of the check.

5. The method of claim 1, further comprising:
analyzing the image to determine an amount of the check automatically with character recognition software.

6. The method of claim 1, further comprising:
reading MICR data on the check automatically.

7. The method of claim 1, further comprising:
verifying the authenticity of the check.

8. The method of claim 1, further comprising:
transmitting a first communications signal comprising the image of the check,
wherein the verifying step comprises receiving a second communications signal which confirms that the image is of sufficient quality to comprise a substitute check.

9. The method of claim 1, further comprising:
transmitting a first communications signal comprising a request to authorize a transaction with the check received at the ATM; and
receiving a second communications signal which authorizes the transaction.

10. The method of claim 9, further comprising:
distributing cash to the user,
wherein the transaction comprises cashing the check via the ATM.

11. A method for processing a check transaction at an Automatic Teller Machine (“ATM”) network host computer system comprising:
receiving, at an ATM network host computer system, a first communications signal from the ATM comprising an image of a check and a request for a transaction;
verifying that the image meets an established quality standard for check images received at the ATM network host computer system;
determining whether the transaction is authorized; and
transmitting a second communications signal directing the ATM to print on the check to indicate that it is not negotiable and discharge the printed check to the user.

12. The method of claim 11, further comprising:
analyzing the image to determine an amount of the check automatically with character recognition software.

13. The method of claim 11, further comprising:
analyzing the image to read MICR data in the image with image processing software.

14. The method of claim 11, further comprising:
analyzing the image to determine the authenticity of the check.

15. The method of claim 11, further comprising:
receiving an initiating communications signal comprising an account identifier and a personal identification number (“PIN”);
determining that the received PIN matches an other PIN associated with the account identifier; and
transmitting a responsive communications signal authenticating the user.

16. The method of claim 11, wherein,
the request for a transaction comprises an amount and a request to authorize the ATM to cash the check; and
the second communications signal further comprises an authorization for the ATM to cash the check.

17. The method of claim 16, further comprising:
verifying that the account associated with the check has a sufficient balance to cover the check.

18. The method of claim 16, further comprising:
verifying that the account associated with the user has a sufficient balance to cover the check.

19. The method of claim 11, further comprising:
directing an amount of the check to be deposited into an account associated with the user,
wherein the request for a transaction comprises a request to deposit the amount of the check into the account associated with the user.

20. A system for processing a check transaction in an Automatic Teller Machine (“ATM”) network, the system comprising:
an ATM comprising an input device, an image capture device, and a printer, wherein the ATM is configured to:
receive a check from a user via the input device;
capture an image of the check with the image capture device;
transmit a first communications signal comprising the image of the check and an associated request for a transaction;
receive a second communications signal directing the ATM to print on the check to indicate that it is not negotiable and discharge the printed check to the user; and
print on the check with the printer to indicate that the check is not negotiable and discharge the printed check from the ATM to the user; and
an ATM network host computer system, in communication with the ATM, wherein the ATM network host computer system is configured to:
receive the first communications signal;
determine that the transaction is authorized; and
transmit the second communications signal.

21. The system of claim 20, wherein,
the ATM is further configured to:
receive an ATM card and input of a user comprising a personal identification number (“PIN”);
transmit an initiating communications signal comprising an encrypted, formatted message including an ATM card number and a PIN;
receive a responsive communications signal from the ATM network host computer system comprising an encrypted, formatted message which verifies that the received PIN matches an other PIN associated with the ATM card number; and
receive input of the user comprising a request to deposit a check into an account of the user; and
the ATM network host computer system is further configured to:
receive the initiating communications signal;
determine whether the received PIN matches the PIN associated with the ATM card number; and
transmit the responsive communications signal.

22. An apparatus to provide check processing, comprising:
an input interface which allows a user to input information;
an input device configured to receive and discharge a check from a user;
an image capture device configured to capture an image of the check;
a printer configured to print on the check;
a processor; and
a computer readable medium comprising instructions executable by the processor to:
receive input from a user through the input interface;
direct the image capture device to capture the image of the check;
direct the printer to print on the check with an indication that the check is not negotiable; and
discharge the check from the input device to the user.

23. The apparatus of claim 22, wherein the image capture device is configured to capture both sides of the check in the image of the check.

24. The apparatus of claim 22, wherein the image capture device further comprises a MICR reader.

25. The apparatus of claim 22, further comprising:
a communications interface,
wherein the instructions are further executable by the processor to transmit a communications signal comprising an encrypted, formatted message via the communications interface.

26. The apparatus of claim 22, wherein the instructions further direct the printer to print on the check with information selected from the group consisting of: date, time, terminal ID, location, ATM card number, other transaction identification information, other information about the user, other terms which indicate that the check is no longer negotiable, and any combination thereof.

27. A computer program embodied on at least one computer readable medium, the computer program comprising instructions executable by a computer to:
receive a check from a user;
capture an image of the check;
verify that the image meets a quality standard established for the image captured;
direct a printer to print on the check to indicate that the check is not negotiable; and
discharge the check to the user.

28. The program of claim 27, wherein the computer-readable program further includes instructions to:
transmit a first communications signal comprising the image of the check,
wherein the verify step comprises instructions to receive a second communications signal which indicates that the image meets the quality standard.
